(19) United States
(12) Patent Application Publication
(10) Pub. No.: US 2012/0194030 A1
(43) Pub. Date: Aug. 2, 2012

(54) Force Balanced Multivoltage Winding Configuration

(75) Inventors: Gerald W. BROWN, Radford, VA (US); Ethan Filip, Christiansburg, VA (US); Bradley A. Trago, Blacksburg, VA (US); Stephen Funk, Blacksburg, VA (US); Jeffrey T. Brewster, Dublin, VA (US)

(73) Assignee: Kollmorgen Corporation, Radford, VA (US)

(21) Appl. No.: 13/360,191

(22) Filed: Jan. 27, 2012

Related U.S. Application Data
(60) Provisional application No. 61/437,868, filed on Jan. 31, 2011.

(51) Int. Cl. H02K 1/12

(52) U.S. Cl. 310/254.1

(57) ABSTRACT

A stator arrangement for a balanced multiple voltage device operable as an electric motor, a generator, or a motor-generator includes a plurality of arc sectors configured so as to surround a rotor of the device. Each of the arc sectors includes a set of stator windings with at least one winding in each set. Those windings in pairs of the arc sectors located at diametrically opposed locations of the stator arrangement are concurrently energized and deenergized in order to eliminate load imbalance on the device.

This application claims priority under 35 U.S.C. §119(e) to U.S. provisional application Ser. No. 61/437,868, filed Jan. 31, 2011, the entire disclosure of which is incorporated by this reference into the present application.

### BACKGROUND OF THE INVENTION

1. Field of the Invention

This invention concerns an improved stator arrangement for a device operable as an electric motor, a generator, or a motor-generator.

2. Description of Related Art

U.S. Pat. No. 6,242,884 to Lipo et al. discloses a dual stator winding induction machine having a pair of windings with input terminals that are supplied separately with drive power. The two stator windings have a different number of poles to avoid magnetic coupling and to decouple torques produced by the windings.

U.S. Pat. No. 6,710,495 to Lipo et al. discloses a motor having a pair of three-phase windings, with power provided to the windings by two power supplies at the same fundamental frequency and with a component at a third harmonic of the fundamental frequency.

U.S. Pat. No. 7,365,504 to Kroeger discloses a motor provided with multiple sets of independent stator windings that are magnetically decoupled to provide for increased overall torque as needed.

The disclosures of the Lipo et al. ('884) patent, the Lipo et al. ('495) patent, and the Kroeger ('504) patent are all incorporated herein in their entireties as non-essential subject matter.

There is a desire to have a brushless generator and electronic drive system that can provide significant power at different output voltages such as, for example, 28 VDC, 120 VAC, and 240 VAC. This is generally accomplished by winding the generator to one voltage, such as the highest of the voltages, using an electronic drive AC to DC converter to provide the VDC output, and using a transformer or an electronic AC to AC converter to provide the other AC output. This solution is large, heavy, inefficient, and complex. The various powers at the different output voltages can vary widely with time. At one time, for example, the power required at 28 VDC may be zero, while full load power is required from the 240 VAC output.

Using standard windings with a winding span of more than one slot, there is significant coupling between adjacent coils of different parallel segments, causing voltage coupling between windings as described. With single tooth windings, there can be severe force imbalances around the winding on the rotor, which would cause excessive wear on the bearings and noise.

### SUMMARY OF THE INVENTION

One object of this invention is to provide a winding configuration for a three phase brushless motor/generator providing different parallel windings that can be wound for different voltages to be run with different loads such that the windings will be force-balanced, creating negligible net forces on a rotor.

According to the invention, therefore, a stator arrangement for a device operable as an electric motor, a generator, or a motor-generator includes a plurality of arc sectors configured so as to surround a rotor of the device. Each of the arc sectors includes a set of stator windings with at least one winding in each set. Those windings in pairs of the arc sectors located at diametrically opposed locations of the stator arrangement are concurrently energized and deenergized in order to eliminate load imbalance on the device.

A standard solution to the need for power at various voltages generally involves electronic power conversion by way of DC/DC and DC/AC modules. By way of the invention, smaller, lighter, less complex, more efficient, and less expensive solutions to the need for power at different voltages are provided.

Encapsulated windings may be utilized in the invention if appropriate.

### BRIEF DESCRIPTION OF THE DRAWINGS

FIG. 1 is a schematic illustration of a known, dual voltage, three arc generator, with the three arc sectors of the generator equally loaded, and the resulting force vectors on the rotor.

FIG. 2 is a schematic illustration similar to that of FIG. 1, but in which only two of the three generator arc sectors are equally loaded, and one of the generator arc sectors is unloaded.

FIG. 3 is a schematic illustration of a balanced dual voltage design at a 1200 rpm point in accordance with one embodiment of the present invention.

FIG. 4 is a schematic illustration of the design shown in FIG. 3 but at a higher, 1900 rpm point.

FIG. 5 is a schematic illustration of the overall wiring architecture of a system incorporating a balanced dual voltage generator design according to the present invention, illustrating current supply to physically opposite balanced dual voltage generator sectors.

FIG. 6 is a schematic representation of unbalanced forces arising in a generator incorporated in overall system wiring architecture.

### DETAILED DESCRIPTION OF THE INVENTION

Although the following description primarily identifies each arrangement illustrated in the drawings and forming the subject matter of the invention as a “generator,” it is to be understood that the principles discussed are equally applicable to electric motor arrangements, and that the invention is not to be limited only to generator applications.

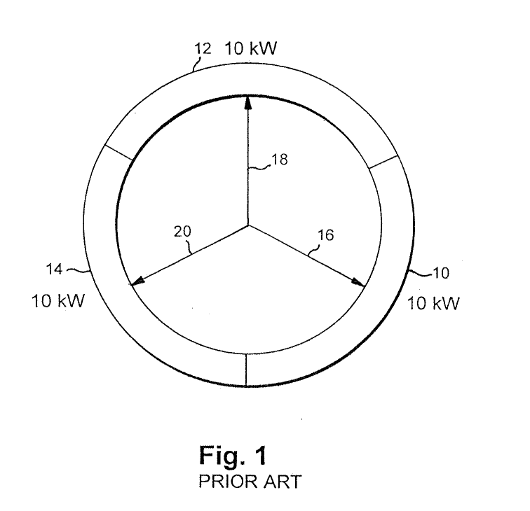

The known, dual voltage generator schematically illustrated in FIG. 1 has three arc sectors 10, 12, and 14. Power output from each arc sector 10, 12, and 14 may be 10 kW, for example. As is evident from the illustration, when the arc sectors are equally loaded, the resulting force vectors 16, 18, and 20 on the generator rotor (not shown) balance.

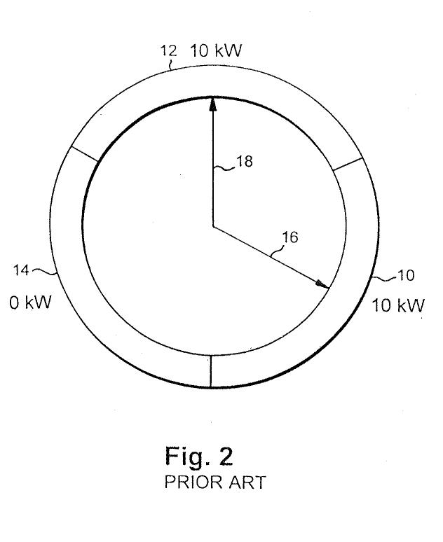

Issues arise during use of known dual voltage generator designs due to magnetically unbalanced loading caused by unequal electrical loading and adjacent arc construction. FIG. 2, for example, illustrates the generator of FIG. 1 when two adjacent arc sectors 10 and 12 are equally loaded, but the third arc sector 14 is unloaded. Here, power output from each of the arc sectors 10 and 12 may be 10 kW, for example, while power output from the remaining arc sector 14 may be 0 kW when that arc sector is completely unloaded. In such a situation, without a force vector 20 produced by the arc sector 14 on the generator rotor, a significant rotating unbalance may be produced by the presence of force vectors 16 and 18. In one instance, such an imbalance was approximately 400 lbs. multiple times per rotor revolution.

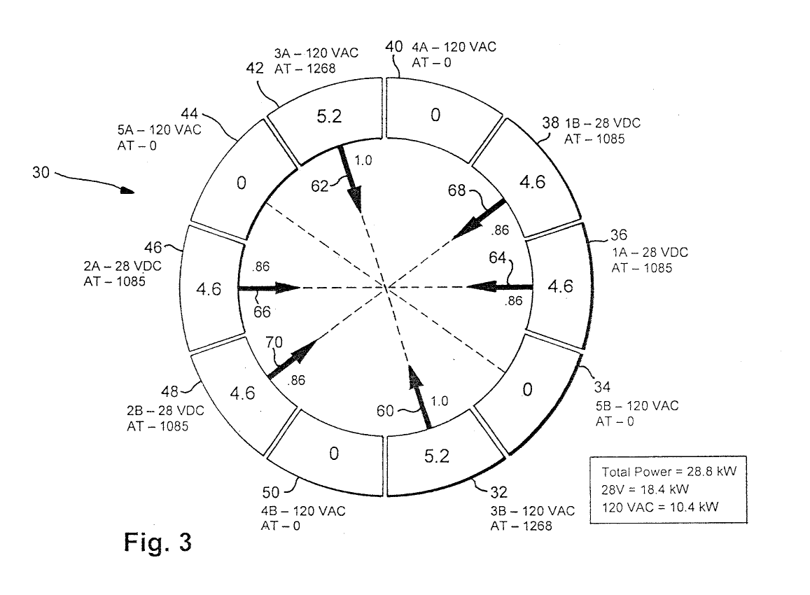

FIG. 3 schematically shows one embodiment of a balanced dual voltage generator (or motor) 30 according to the present invention. When conditions identified in FIG. 3 and noted in this description of FIG. 3 are present, it is presumed that the winding configuration shown operates with a 1200 rpm rotor input. The generator 30 includes ten arc sectors forming opposing arc sector pairs, with each such pair sharing a respective drive bus. As will be explained, such a configuration is balanced, in that the force vectors on the motor or generator rotor sum to zero.

In the FIG. 3 arrangement, arc sectors 32 and 42, together, form a first arc sector pair, arc sectors 34 and 44, together, form a second arc sector pair, arc sectors 36 and 46, together, form a third arc sector pair, arc sectors 38 and 48, together, form a fourth arc sector pair, and arc sectors 40 and 50, together, form a fifth arc sector pair. Multiple individual windings are included in each of the arc sectors. Under the conditions indicated, each of the arc sectors 32 and 42 of the first arc sector pair operates at 120 VAC to produce 5.2 kW, each of the arc sectors 34, 44 and 40, 50 of the second and fifth pairs is inoperative, and each of the arc sectors 36, 46, and 38, 48 of the third and fourth pairs operates at 28 VDC to produce 4.6 kW. Accordingly, under the conditions indicated, the power output at 28 VDC is 18.4 kW, the power output at 120 VAC is 10.4 kW, and the total power output is 28.8 kW.

FIG. 3 also identifies scaled force vectors on the generator rotor from the AT (ampere-turns) of each sector. Under the conditions indicated in FIG. 3, the 1268 AT from each of the arc sectors 32, 42 of the first pair is considered to constitute a scaled force vector 60, 62, respectively, of 1.0. Accordingly, the 1085 AT from each of the arc sectors 36, 46, and 38, 48 of the third and fourth pairs constitutes respective scaled force vectors 64, 66, and 68, 70 of 0.86. A force vector of zero magnitude (i.e., no force vector) is associated with each of the inoperative second and fifth arc sector pairs 34, 44 and 40, 50.

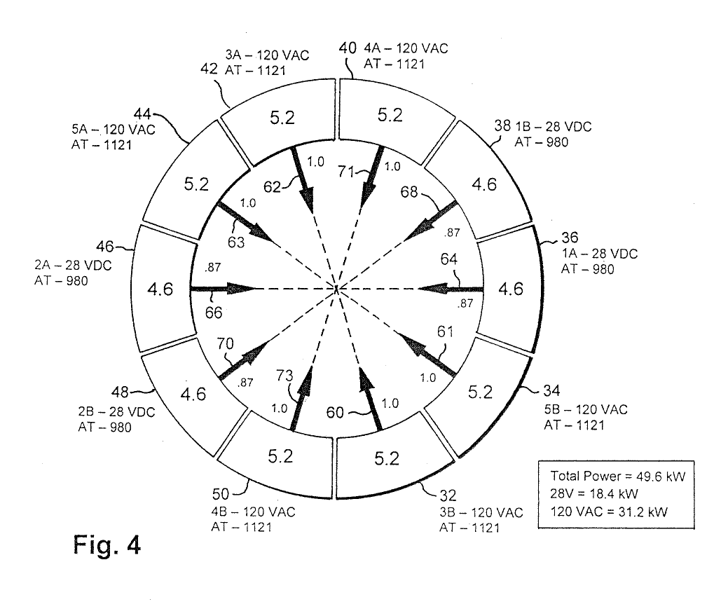

FIG. 4 schematically shows a balanced dual voltage generator (or motor) 30 according to the present invention, but under different conditions. When conditions identified in FIG. 4 and noted in the present description of FIG. 4 exist, it is presumed that the winding configuration shown operates with a 1900 rpm rotor input. As before, this configuration is balanced, so that the force vectors on the generator rotor sum to zero.

Under the conditions indicated in FIG. 4, each of the arc sectors 32, 42, 34, 44, and 40, 50 of the first, second, and fifth arc sector pairs operates at 120 VAC to produce 5.2 kW, while each of the arc sectors 36, 46 and 38, 48 of the third and fourth pairs operates at 28 VDC to produce 4.6 kW. Accordingly, under the conditions indicated, the power output at 28 VDC is 18.4 kW, the power output at 120 VAC is 31.2 kW, and the total power output is 49.6 kW.

FIG. 4 also identifies scaled force vectors on the generator rotor from the AT of each sector. Under the conditions indicated in FIG. 4, the 1121 AT from each of the arc sectors 32, 42, 34, 44, and 40, 50 of the first, second, and fifth arc sector pairs is considered to constitute a scaled force vector 60, 62, 61, 63, and 71, 73 respectively, of 1.0. Accordingly, the 980 AT from each of the arc sectors 36, 46, and 38, 48 of the third and fourth pairs constitutes respective scaled force vectors 64, 66, and 68, 70 of 0.87.

In each mode of operation, by way of the geometric arrangement of arc sectors in the overall generator or motor 30, forces on the motor or generator rotor are balanced, with the force vectors producing loads on the rotor summing to zero. This is accomplished by arranging corresponding arc sectors sharing a drive bus at 180° relative to, i.e. directly opposite, each other. By way of a balanced dual voltage arrangement configured in the manner described, a balanced magnetic force loading is ensured, regardless of overall load imbalance on the generator or motor 30. As the output wattage in each sector is also disposed directly opposite to corresponding output wattage, reasonably symmetrical heating is observed.

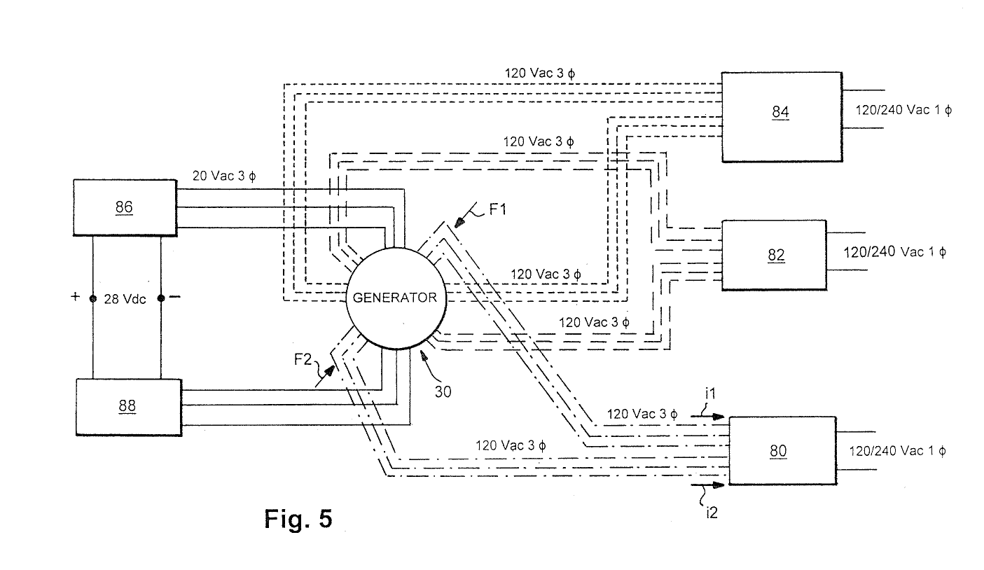

A schematic illustration of an overall wiring architecture of a system incorporating a balanced dual voltage generator 30 according to the present invention is provided by FIG. 5. By way of example only, it will be presumed that the system shown in FIG. 5 includes three 120 VAC drives 80, 82, and 84, and two 28 VDC drives 86 and 88. It will be recognized that the generator 30 utilized in the system of FIG. 5 includes eight arc sectors rather than the ten arc sectors illustrated in FIGS. 3 and 4. To supply current to each individual drive 80, 82, 84, 86, or 88, arc sectors that are directly opposite to each other are used together. Thus, if current is to be supplied to power the 120 VAC drive 80 only, but not to power any of the other drives 82, 84, 86, and 88, then two arc sectors located at 180° relative to, i.e. directly opposite, each other within the generator 30 are utilized to provide the necessary power. The currents i1, i2 supplied by these sectors to the drive 80 will be identical. Although force vectors of zero magnitude (i.e., no force vectors) are associated with the other 6 inoperative arc sector pairs, identical loads F1 and F2 on the generator rotor (not shown) produced by the single pair of operative arc sectors oppose each other, since the two operative arc sectors themselves are located at 180° relative to, i.e. directly opposite, each other. The generator 30 has magnetic balance by locating these loads F1 and F2 directly opposite each other, and rotational imbalance and associated wear on the generator rotor and/or its supporting components is minimized.

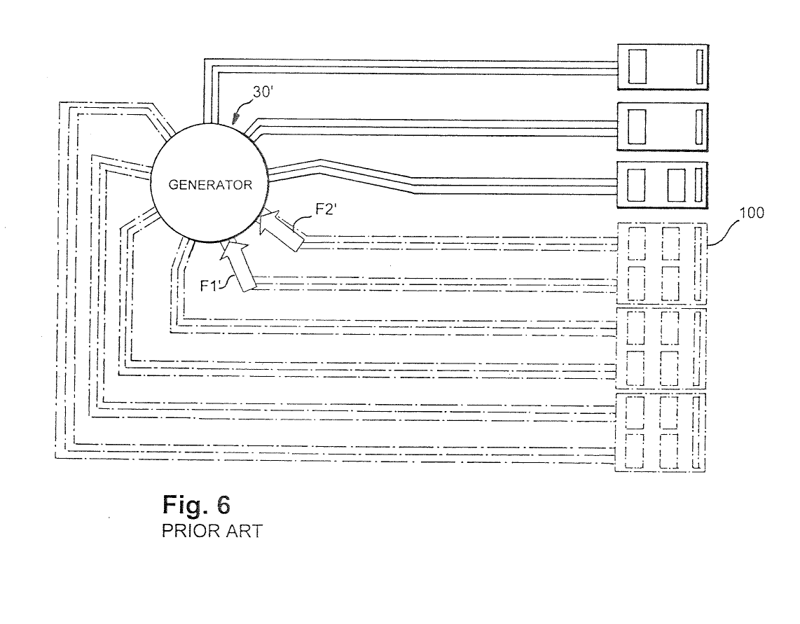

FIG. 6 schematically illustrates the manner in which rotational imbalance on a generator rotor might be produced in an arrangement utilizing voltage generator arc sectors for the relevant drive 100 that are not located directly opposite to each other. Since the arc sectors of the generator 30′ producing the loads F1′ and F2′ represented in FIG. 6 are physically adjacent to each other, the potential for a large force imbalance exists. While the loads F1′ and F2′ shown in FIG. 6 may be identical in magnitude, these loads F1′ and F2′ do not oppose each other, and adverse effects on a generator rotor or its bearings due to rotational imbalance can be exacerbated.

From the foregoing, it will be apparent that the present invention utilizes a winding for the brushless motor/generator with many parallel segments, each of which can be wound with the appropriate number of turns to provide the needed input AC voltages to drives that then directly provide the power at the needed out AC output voltage or rectify it to the needed DC voltage without further conversion. The parallel windings are selected such there are always pairs of parallel winding segments that are 180° mechanical degrees apart. Each required voltage/power is shared from the pair of windings, which insures that the opposed windings have the same current and, therefore, the same AT. This assures that the opposing pair of windings always produces the same force on the rotor, which, in turn, assures that the net force on the rotor is zero, since the windings at issue are 180° mechanical degrees apart.

The pairs of parallel winding segments mentioned can be connected in two ways. First, one each of the corresponding coils of the same phase that are 180° mechanical apart can be wound in series. This forces the coils to have a shared output and always to have balanced currents, and therefore forces. A second way is simply to take the winding segment of one side out to a given voltage drive and load and its matching set 180° mechanically opposing segment, out to a separate drive and load, but of the same voltage. These drives can be connected in parallel on the output, so that they nominally share the load. In this case force balance depends on the drives ensuring equal currents in the opposing winding segments. This second method simplifies the connection of the opposing segments, eliminating the routing of interconnection wires around 180° mechanical.

A further consideration in winding selection is the risk of having mutual coupling between windings that feed different loads. This is especially true of windings with different turns. Any mutual coupling between windings means that the drives controlling the voltage and current in these windings are susceptible to two problems:

1. Pulse-width modulation (pwm) switching of the voltage may not be synchronized, and, therefore, there can be induced voltages from the pwm switching in one winding to a neighboring winding.

2. Voltage would be induced from one winding to the other at the fundamental electrical frequency from mutual coupling, and that voltage can interfere with the control of the currents in each winding.

Accordingly, it is desirable to use a winding that is a concentrated or single tooth Winding, so that there is a “span” of one, and the coil is wound around a single tooth so as to have minimum mutual coupling with neighboring teeth.

Examples of windings that meet the above criteria would be slot/pole combinations such as 30 slots/20 poles and 48 slots/32 poles. In other words, slot/pole ratios of 3/2, where two is a common factor of both the number of slots and the number of poles of the combination, are preferable.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1. A stator arrangement for a device operable as an electric motor, a generator, or a motor-generator, comprising:
a plurality of arc sectors configured so as to surround a rotor of the device, each of said arc sectors including a set of stator windings with at least one winding in each set,
wherein those windings in pairs of the arc sectors located at diametrically opposed locations of said stator arrangement are concurrently energized and deenergized in order to eliminate load imbalance on the device.

2. The stator arrangement according to claim 1, wherein the arc sectors located at the diametrically opposed locations share a drive bus.

3. The stator arrangement according to claim 1, wherein at least one pair of the arc sectors is utilized in connection with an alternating current drive and at least one other pair of the arc sectors is utilized in connection with a direct current drive.

4. The stator arrangement according to claim 1, wherein the windings in the pairs of arc sectors are wound in series so as to have a shared output and balanced currents.

5. The stator arrangement according to claim 1, wherein the windings in the pairs of are sectors are connected to drives with identical voltages and loads.

6. The stator arrangement according to claim 1, wherein each of the windings is wound around only a single stator tooth.

7. The stator arrangement according to claim 1, wherein the device has a 3/2 slot to pole ratio.

8. The stator arrangement according to claim 1, wherein at least eight of the arc sectors surround the rotor.

9. The stator arrangement according to claim 1, wherein ten of the arc sectors surround the rotor.

10. A balanced multiple voltage device, comprising:
a plurality of arc sectors configured so as to surround a rotor of the device, each of said arc sectors including a set of stator windings with at least one winding in each set,
wherein those windings in pairs of the arc sectors located at diametrically opposed locations of a stator arrangement of the device are concurrently energized and deenergized.

11. The balanced multiple voltage device of claim 10, wherein the device is a multiple voltage generator.

12. The balanced multiple voltage device of claim 10, wherein the device is a motor.

13. The balanced multiple voltage device of claim 10, wherein the device is a motor-generator.

14. The balanced multiple voltage device of claim 10, wherein the arc sectors located at the diametrically opposed locations share a drive bus.

15. The balanced multiple voltage device of claim 10, wherein at least one pair of the arc sectors is utilized in connection with an alternating current drive and at least one other pair of the arc sectors is utilized in connection with a direct current drive.

16. The balanced multiple voltage device of claim 10, wherein the windings in the pairs of arc sectors are wound in series so as to have a shared output and balanced currents.

17. The balanced multiple voltage device of claim 10, wherein the windings in the pairs of arc sectors are connected to drives with identical voltages and loads.

18. The balanced multiple voltage device of claim 10, wherein each of the windings is wound around only a single stator tooth.

19. The balanced multiple voltage device of claim 8, wherein the device has a 3/2 slot to pole ratio.

20. The balanced multiple voltage device of claim 10, wherein at least eight of the arc sectors surround the rotor.

21. The balanced multiple voltage device of claim 10, wherein ten of the arc sectors surround the rotor.
